(19) United States
(12) Patent Application Publication
(10) Pub. No.: US 2014/0118681 A1
(43) Pub. Date: May 1, 2014

(54) TEMPORARY PHOTOCHROMIC PATCH FOR AN OPHTALMIC LENS

(71) Applicants: Hao Wen Chiu, Holden, MA (US); Matthew James Lockwood, Oak Point, TX (US)

(72) Inventors: Hao Wen Chiu, Holden, MA (US); Matthew James Lockwood, Oak Point, TX (US)

(73) Assignee: Essilor International (Compagnie Generale d'Optique), Chareton-le-Pont (FR)

(21) Appl. No.: 14/125,760

(22) PCT Filed: Jul. 1, 2011
(86) PCT No.: PCT/US2011/042741

§ 371 Date: Dec. 12, 2013

(51) Int. Cl. G02C 7/10

(52) U.S. Cl. CPC G02C 7/102
USPC 351/44; 351/159.81

(57) ABSTRACT

A process for making a temporary photochromic patch for an ophthalmic lens. A photochromic dye is dissolved in either a siloxane base or curing agent. The base and curing agent are combined to initiate a polymerization reaction that will result in a polydimethylsiloxane (PDMS) polymer matrix having sufficiently low molecular weight to accommodate the photochromic dye's mobility. The polymerization reaction is completed in a form to create a viscoelastic patch. The resulting patch can be trimmed and temporarily applied to an ophthalmic lens without needing adhesive.

### BACKGROUND OF THE INVENTION

1. Field of the Invention

The invention relates to an optical quality patch that can temporarily impart photochromic properties to an ophthalmic lens.

2. The Prior Art

Photochromic materials are capable of switching between a state where they are relatively colorless to a state where they are colored. The materials change states based on the amount and wavelength of radiation they encounter. Certain photochromic dyes are used in the ophthalmic industry to provide clear lenses indoors, where the lenses can undergo varying degrees of tinting upon exposure to sunlight. When the sunlight exposure is removed, the lenses return to their clear state.

Typically, ophthalmic lenses are clear, tinted or photochromic. To manufacture photochromic lenses, the photochromic dyes are incorporated into the lens material, into an overmold layer, into a laminated layer or into the lens coating. These various incorporation methods are complex and expensive.

The materials used to make lenses and coatings are selected for strength and scratch resistance. These characteristics are generally hostile to photochromic dyes, which require less rigid matrices in order to switch or rotate between states. In U.S. Published Application 2007-0112103, a photochromic compound is incorporated in a polymer matrix selected from the group consisting of polydimethylsiloxane, poly(hexyl acrylate), poly(butyl methacrylate), poly(ethylhexyl methacrylate), poly(benzyl methacrylate), poly(styrene-co-hexyl acrylate), poly(benzyl methacrylate-co-hexyl methacrylate), poly(methyl methacrylate-co-hexyl acrylate), condensation polymers, addition polymers, and mixtures thereof. The condensation and addition polymers may be aliphatic, aromatic, or a mixture of aliphatic and aromatic. Condensation polymers include polyamides, polyesters, urethanes and polycarbonates, in the patent application, the photochromic compound is disposed in the junction between two electrodes where it can switch between three or four states upon exposure to radiation, an acid or a base.

Currently there is no known technology to temporarily convert clear lenses to photochromic lenses. Furthermore, there is no existing photochromic technology that can be temporarily applied to all types of lens material and lens configurations.

### SUMMARY OF THE INVENTION

Therefore, it is an object of the invention to provide a temporary photochromic film (or patch) that could be easily applied to a pair of eyeglasses.

It is a further object to provide a temporary patch that can be used to demonstrate the benefit of photochromic function to a spectacle wearer.

It is yet another object to provide such a patch that is flexible and can easily conform to the various shapes and curvatures of lenses.

It is a further object to provide a matrix having a low molecular weight to facilitate the incorporation of such dye and allow for its mobility.

It is another object to provide a photochromic patch that can be applied to the lens without adhesive.

These and other related objects are achieved by the photochromic patch according to the invention and the related process for making a photochromic patch. The process includes a first step of providing a siloxane base as a first reactant and a siloxane curing agent as a second reactant. A photochromic dye is dissolved into one of the reactants to form a first dye mixture. The first dye mixture is combined with the other reactant to initiate a polymerization reaction that will result in a polydimethylsiloxane (PDMS) polymer matrix. The polymerization reaction is completed within a form to create a viscoelastic patch. The patch is configured to a lens shape and temporarily applying the configured patch to an ophthalmic lens to impart photochromic properties.

Additional quantities of a photochromic dye are dissolved into additional quantities of polydimethylsiloxane (PDMS) to form a second dye mixture. The combining step includes combining the first dye mixture, the other reactant and the second dye mixture. The completing step includes degassing the combined base and curing agent to create a viscoelastic patch with reduced air bubbles which comprises a functional film of optical quality. The combined base and curing agent are degassed under a vacuum in the range of 20 to 40 in-Hg for at least 30 minutes. The combined base and curing agent are cured at a temperature between about 65 to 85 degrees Celsius for about 1 to 1.5 hours.

The configuring step includes trimming the patch to match the lens perimeter shape and applying the patch to the ophthalmic lens in the absence of an adhesive and at room temperature where the viscoelastic patch is tacky. The configuring step further includes placing the patch on a curved surface during one of a high temperature condition or a long flow time, so that the patch flows to conform to the shape of the curved surface. The configuring step also includes applying a lubricant to the lens prior to applying the patch to the lens, wherein the lubricant allows the patch to slide on the lens for easy alignment and where the lubricant displaces air bubbles.

The siloxane base comprises dimethylsiloxane and the curing agent comprises dimethyl methylhydrogen siloxane, and wherein the first dissolving step includes heating the one reactant to facilitate dissolving the photochromic dye. A further embodiment of the invention relates to a temporary photochromic patch for an ophthalmic lens made according to the process described above.

Another embodiment of the invention relates to a temporary photochromic patch for an ophthalmic lens. The lens includes a silicone elastomer patch made from a siloxane base and a curing agent with photochromic dye present in an amount of about 0.5 to 1.0 part per hundred base. The silicone elastomer patch is made from a polydimethylsiloxane (PDMS) polymer matrix. The silicone elastomer patch is a degassed patch having reduced entrapped air bubbles and comprising a functional film of optical quality.

The patch is trimmable to the peripheral size of an ophthalmic lens and possesses a tacky surface that can attach to an ophthalmic lens in the absence of adhesive. The patch can conform to the curved surface of the ophthalmic lens under a high temperature condition or a long flow time in combination with the patch, a lubricant applied to the patch to facilitate alignment on the ophthalmic lens surface. The combination further includes an ophthalmic lens having a surface, wherein the patch is applied to the surface with a lubricant sandwiched therebetween. The siloxane base comprises dimethylsiloxane and the curing agent comprises dimethyl methylhydrogen siloxane.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1 is a flowchart showing various steps for making the photochromic patch according to the invention.

FIG. 2 is a graph showing photochromic responses of patches made according to the invention.

### DETAILED DESCRIPTION OF THE PREFERRED EMBODIMENTS

There has been a long-standing need to be able to demonstrate photochromic function to wearers of clear prescription eyeglasses. That is to show them how a photochromic lens would appear with their exact frame and lens prescription (Rx). A related need is the ability to give 2nd life to old eyeglasses through the incorporation of a photochromic film. Furthermore, it would be desirable to be able to transform a pair of existing clear eyeglasses into photochromic lens within a few minutes at the offices of an eye care professional (ECP). Such a photochromic patch would need to be easily applied onto an existing lens without the need of special equipment or materials. Basic requirements of such patches include acceptable photochromic performance and flexibility to conform to different lens shapes or curves. It is also preferred if the patches can adhere to the lenses of existing eyeglasses without using adhesive.

To address these needs, the present invention provides a temporary photochromic patch and method of making same for applying to a lens to obtain a photochromic function. More specifically, polydimethylsiloxane (PDMS) photochromic patches were created by first mixing photochromic dyes into the reactants then initiating the curing reaction to form thin silicone patches that turn dark when expose to sunlight.

The proposed solution is to make photochromic patches using polydimethylsiloxane (PDMS). PDMS is an optically clear silicone elastomer. It is viscoelastic, which means it behaves like an elastic solid (similar to rubber) at low temperature or short flow time but acts like a viscous liquid (similar to honey) at high temperature or long flow time. Therefore, if some PDMS is left on a surface at room temperature for a long period of time, it will flow to conform to the shape of the surface and replicate any surface textures. This makes is possible for a flat piece of PDMS patch to take the shape of a curved lens surface. The same PDMS is rubbery and slightly tacky at room temperature making it easier to handle and adhere to a surface without the use of any adhesive. All these advantageous properties of PDMS make it an ideal candidate for photochromic patches that can be easily applied onto existing eyeglasses. Furthermore, it is important to note that the matrix wherein the photochromic dyes will be incorporated, need to have a low molecular weight. Without this physical parameter, dye cannot be incorporated easily to the necessary concentration to obtain a relevant photochromic effect.

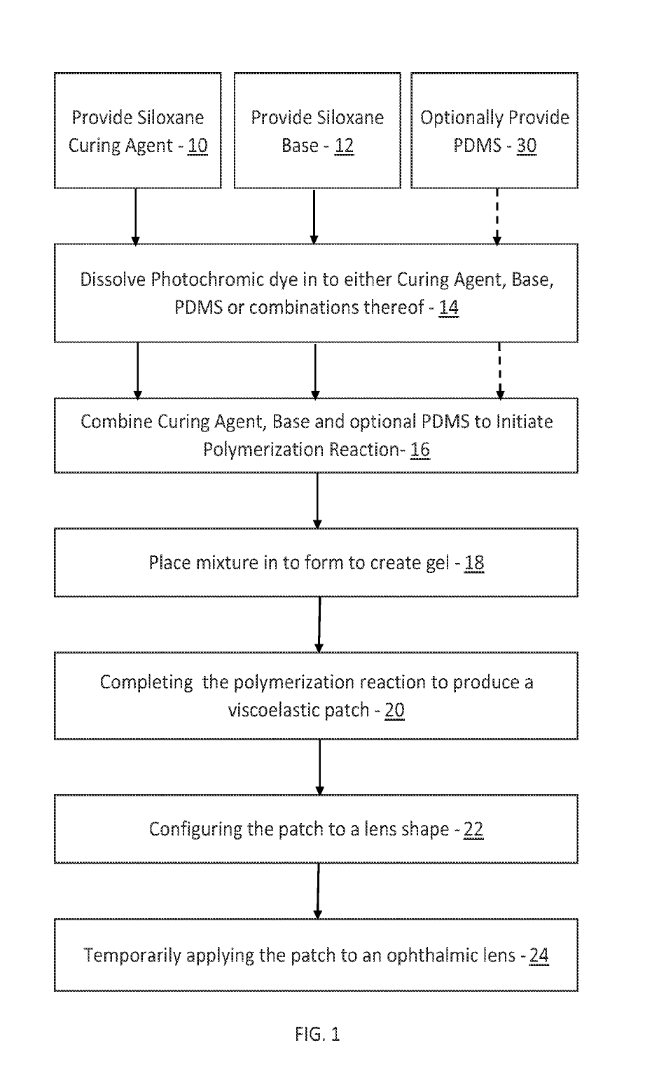

The process for making a photochromic patch according to an embodiment of the invention is illustrated in the flowchart of FIG. 1. Initially, there is provided a siloxane curing agent 10 and a siloxane base 12 which can be combined and polymerized to form an optically clear silicone elastomer. To actually produce a photochromic PDMS patch, it is necessary to introduce photochromic dyes into the polymer matrix. Typically, PDMS is formed by mixing together in certain ratio the dimethylsiloxane base and the curing agent (or crosslinker) such as dimethyl methylhydrogen siloxane that thermally initiates the polymerization reaction. Therefore, the most easiest and effective way to incorporate photochromic dyes into the system is to dissolve the dyes into individual reactants (either the base or the curing agent or both) of the reaction mixture before raising the temperature to start polymerization, per step 14. Optionally, for improving the darkening performance, additional photochromic dyes can be dissolved into low molecular weight PDMS silicone oil per step 30, which is then added to the reaction mixture in combining step 16 before polymerization.

In the examples, the added dye and curing agent are measured in “parts per hundred base” (phb). The base is shown in step 12. The curing agent of step 10 is typically added in an amount of between 5-10 phb. If the dye of step 14 is added to the curing agent, it would be added in an amount between 0.1 and 1.0 phb, preferably about 0.5 phb. If the dye of step 14 is added to the base, it would be added in an amount between 0.1 and 1.0 phb, preferably about 0.5 phb. The PDMS of step 30 could be added in an amount up to 20 phb, or in an amount between 10 and 20 phb. If the dye of step 14 is added to the PDMS, it would be added in an amount between 0.1 and 1.0 phb, preferably about 0.5 phb.

According to the invention, any known optical photochromic dye can be used. For example, naphthopyrans, fulgides, benzopyrans, fulgimides, spironaphthopyrans, spirobenzoxazines, spironaphthoxazines, spirobenzopyrans, and combinations. The dyes can be blended to achieve different performance or cosmetic characteristics.

If the dye is added to the curing agent, the mixture may be heated and mixed to assist in dissolving the dye in to the solution. The mixture may be heated to a temperature in the range of 110 to 195 degrees Celsius, preferably in the range of about 130 to 175 degrees Celsius. If the dye is added to the PDMS, the mixture may be heated and mixed to assist in dissolving the dye in to the solution. The mixture may be heated to a temperature in the range of 110 to 150 degrees Celsius, preferably about 130 degrees Celsius. The dye dissolved in solution is then cooled to room temperature before combining it with the base.

During the polymerization step 20, the form may be placed in a vacuum oven for heating and degassing. In the following examples, polymerization comprises thermal initiation. In other chemical systems that provide the same functionality and mechanical properties, polymerization may consist of UV cure. The vacuum is in the range of 20 to 40 in-Hg, preferably about 30 in-Hg. The temperature is in the range of 65 to 85 degrees Celsius, preferably about 75 degrees Celsius. The mixture is heated under vacuum for 40 to 80 minutes, preferably about 60 minutes. It will be understood by those skilled in the art, that a lower vacuum may adequately degass under warmer or longer processing conditions.

After obtaining the photochromic dye containing reaction mixture, it is then casted into a form per step 18, or glass dish (or other flat surfaces) or poured into a cavity formed by two opposite-faced optical molds separated by a spacer of desired thickness. The whole assembly is then placed into an oven, preferably a vacuum oven for easy removal of air bubbles from mixing, and the temperature is raised to about 75° C. and held for at least 1 hour to complete the curing reaction per step 20 forming the PDMS patch.

To apply a photochromic patch onto a lens of existing eyeglasses, the patch is first cut into the shape of the lens by ECP with a pair of scissors or a die-cutter, per step 22. Subsequently, the ECP applies some soapy water on the front surface of the target lens then patch is applied onto the lens, per step 24. The soapy water acts as a lubricant that allows the patch to slide on the surface of the lens for easy alignment of the two and also for preventing the trapping of air bubbles. The newly formed photochromic eyeglasses are ready to be wear after the water is dried (in about 10-15 minutes at room temperature). The photochromic patches can also be removed easily to revert back to the original eyeglasses as there is no permanent bonding between the patches and the lenses.

The requirements can be achieved by providing a base and a curing agent, where a photochromic dye is dissolved into either the base, the curing agent or both. The dissolved dye, base and curing agent are combined to initiate polymerization. A further polymer containing additional quantities of photochromic dye may optionally be added to the dye, base and curing agent mixture. The mixture is introduced in to a form where the polymerization reaction is completed to create a viscoelastic patch. The further polymer and the resulting polymer matrix may be the same or different materials, although in a preferred embodiment, they comprise the same material or chemically-related materials. The molecular weight is one way to express the polymer's size, i.e. the length of the chain, or degree of polymerization. In general, tensile strength increases with polymer chain length. Internally, a higher tensile strength means less local flexibility for photochromic dye mobility or switching action. That is, the dye's rotating between the flat colorless state, and the perpendicular colored state.

The viscoelastic patch comprises a functional film of optical quality. The viscoelastic patch is readily trimmed to match the peripheral shape of the host lens. The patch can conform to the curvature and shape of other lens features when heated or allowed a long flow time. The viscoelastic is tacky and will stick to most lens materials. A lubricant, adhesive or other fluid may be applied between the lens and patch to facilitate placement. The patch provides a photochromic functions that can be added to existing spectacles within a few minutes, or less than half an hour. If the patch is applied in the absence of adhesive, it can be easily removed without any damage to the spectacles.

### EXAMPLE I

### Mold Max 27T Silicone Kit

Photochromic PDMS patches were prepared using Mold Max 27T silicone kit (available from Smooth-On) according to the following procedure:

1. Mold Max 27T part-A measuring at 26.3 grams was poured into a glass beaker.

Next, 0.0281 grams of a mixture of photochromic dye from Transitions Optical, Inc. (TOI) to provide a brown color in the activated state, was added into the beaker in step 1. The amount of the dye was about 0.1 wt % of the part-A of Mold Max 27T. The mixture was then heated on a hot plate to 175° C. to help dissolving the photochromic dye.

3. The mixture in step 2 was let cooled to room temperature (about 25° C.) then 0.26 grams of the part-B of Mold Max 27T were added into the beaker and mixed thoroughly.

4. The resulting mixture of step 3 was poured into a flat-bottom plastic cup. A thin patch of uncured gel-like silicone was formed.

5. The plastic cup was placed in an oven under 30 in-Hg vacuums at 75° C. for about 1 hour to cure the silicone.

The resulting silicone patch turned dark when exposed to sunlight and returned to translucent clear when blocked the sunlight exposure, which demonstrated clearly the photochromic function.

### EXAMPLE II

### Dow Corning Sylgard® 184 Silicone Elastomer Kit

Photochromic PDMS patches were prepared using Dow Corning Sylgard® 184 silicone elastomer kit according to the following procedure:

1. First 0.3312 grams of #170-24-4 B photochromic dye from TOT were dissolved into 3.08 grams of the curing agent of the Sylgard 184 that were heated at 130° C. The resulting mixture was then filtered through a 5 μm filter and let cooled to room temperature.

2. The filtered solution in step 1 was mixed into 30.1 grams of the Sylgard 184 base so that the photochromic dye was about 1 wt % of the base.

3. The resulting mixture of step 2 was poured into a flat-bottom glass dish forming a thin patch (about 1 mm thick) of uncured gel-like silicone.

4. The glass dish was placed in an oven under 30 in-Hg vacuums at 75° C. for about 1 hour to cure the silicone.

The resulting PDMS patch turned dark when exposed to sunlight and returned to clear when blocked the sunlight exposure, which demonstrated clearly the photochromic function.

### EXAMPLE III

### Dow Corning Sylgard® 184 Silicone Elastomer Kit+200® Fluid

Photochromic PDMS patches were prepared using Dow Corning Sylgard® 184 silicone elastomer kit and Dow Corning 200® Fluid 20 CST according to the following procedure:

1. First 0.16 grains of #170-24-4 B photochromic dye from TOI were dissolved into 3.0 grams of the Dow Corning 200® Fluid 20 CST that were heated at 130° C. The resulting mixture was then filtered, through a 5 μm filter and let cooled to room temperature.

2. The filtered solution in step 1 was mixed into 30.0 grams of the Sylgard 184 base at room temperature.

3. Next, 0.162 grams of #170-24-4 B photochromic dye from TOI were dissolved into 1.50 grams of the curing agent of the Sylgard 184 that were heated at 130° C. The resulting mixture was then filtered through a 5 μm filter and let cooled to room temperature.

4. The mixtures of step 2 and step 3 were then mixed together thoroughly at room temperature.

5. The resulting mixture of step 4 was poured into a mold that was formed by two pieces of round glasses, 80 mm in diameter and 4 mm in thickness. Sandwiched in-between the two glass pieces was a 0.75 mm thick annulus spacer having an inside diameter of 70 mm that was die-cut from a polycarbonate sheet.

6. The whole assembly of step 5 was placed in an oven under 30 in-Hg vacuums at 75° C. for about 1 hour to cure the silicone.

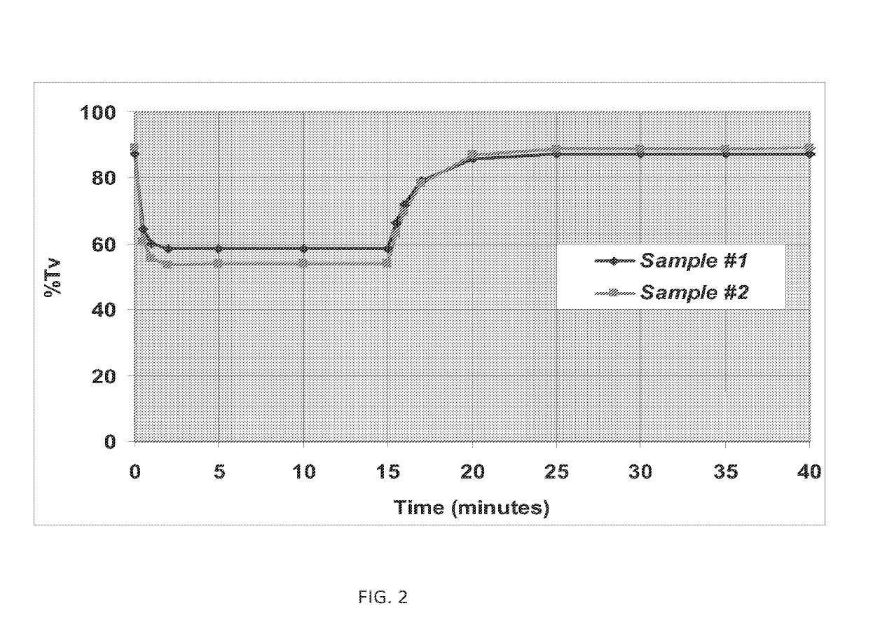

The resulting PDMS patch turned dark when exposed to sunlight and returned to clear when blocked the sunlight exposure, which demonstrated clearly the photochromic function. The photochromic performances of the patches were further characterized using an optical bench. The results are shown in FIG. 2, wherein two samples from Example III were tested. After activation (by exposing the samples to UV), the transmittance (% Tv) of sample #1 decreased rapidly from an initial clear state of 87% to a full darkening state of 59% in about 2 minutes. When deactivated (at time=15 minutes), sample #1 changed from the darkening state back to fully clear in about 10 minutes. Similarly, % Tv of sample #2 decreased from 89% to 54% when activated and turned to fully clear in about 10 minutes when deactivated.

The invention provides a photochromic patch and process for making same. The photochromic patches can be easily trimmed and then flowed to conform to curves and lens feature shapes. The patch can be trimmed with scissors or die cut to the shape of the lens. The trimmed patch can be set upon the lens and heated or given time to flow. The patch can conform to the curvature of the lens and/or lens features, like ledges in bi-focal lenses. They can be applied onto existing eyeglasses to demonstrate the function of photochromism within a few minutes without damaging the eyeglasses. Currently, there is no other means to allow customers to experience photochromic functionality with their own eyeglasses. That is, where they can try photochromics on their own frame and prescription lenses right in the ECPs office.

The tackiness of the viscoelastic patch allows it to stick to most types of organic and inorganic lenses. For example, the viscoelastic patch can stick, with or without soapy water, to glass like crown glass or thermoset plastics like CR-39 and polyurethanes, or thermoplastics like polycarbonate, polyamide, polyimide, polysulfone, copolymers of polyethyleneterephthalate and polycarbonate, polyolefine, homopolymers and copolymers of diethylene glycol bis(allylcarbonate), homopolymers and copolymers of (meth)acrylic monomers, homopolymers and copolymers of thio(meth)acrylic monomers, homopolymers and copolymers of urethane, homopolymers and copolymers of thiourethane, epoxy homopolymers and copolymers, and episulfure homopolymers and copolymers. In addition, the viscoelastic patch can stick, with or without soapy water, to lens coatings, like hard coatings, scratch resistant coatings, anti-reflective coatings, smudge resistant coatings and anti-static coatings.

Having described preferred embodiments for manufacturing patches and the resulting properties of the patches which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A process for making a temporary photochromic patch for an ophthalmic lens, said method comprising the steps of:
providing a siloxane base as a first reactant and a siloxane curing agent as a second reactant;
first dissolving a photochromic dye into one of the reactants to form a first dye mixture;
combining the first dye mixture with the other reactant to initiate a polymerization reaction that will result in a polydimethylsiloxane (PDMS) polymer matrix;
completing the polymerization reaction within a form to create a viscoelastic patch; and
configuring the patch to a lens shape and temporarily applying the configured patch to an ophthalmic lens to impart photochromic properties.

2. The process of claim 2, further comprising the step of:
second dissolving additional quantities of a photochromic dye into additional quantities of polydimethylsiloxane (PDMS) to form a second dye mixture, and wherein said combining step includes combining the first dye mixture, the other reactant and the second dye mixture.

3. he process of claim 1, wherein the completing step includes degassing the combined base and curing agent to create a viscoelastic patch with reduced air bubbles which comprises a functional film of optical quality.

4. The process of claim 3, wherein the combined base and curing agent are degassed under a vacuum in the range of 20 to 40 in-Hg for at least 30 minutes.

5. The process of claim 4, wherein the combined base and curing agent are cured at a temperature between about 65 to 85 degrees Celsius for about 1 to 1.5 hours.

6. The process of claim 3, wherein the configuring step includes trimming the patch to match the lens perimeter shape and applying the patch to the ophthalmic lens in the absence of an adhesive and at room temperature where the viscoelastic patch is tacky.

7. The process of claim 6, wherein the configuring step includes placing the patch on a curved surface during either one of a high temperature condition or a long flow time, so that the patch flows to conform to the shape of the curved surface.

8. The process of claim 3, wherein the configuring step includes applying a lubricant to the lens prior to applying the patch to the lens, wherein the lubricant allows the patch to slide on the lens for easy alignment and where the lubricant displaces air bubbles.

9. The process of claim 1, wherein the siloxane base comprises dimethylsiloxane and the curing agent comprises dimethyl methylhydrogen siloxane, and wherein the first dissolving step includes heating the one reactant to facilitate dissolving the photochromic dye.

10. A temporary photochromic patch for an ophthalmic lens made according to the process of claim 1.

11. A temporary photochromic patch for an ophthalmic lens comprising:
a silicone elastomer patch made from a siloxane base and a curing agent with photochromic dye present in an amount of about 0.5 to 1.0 part per hundred base, wherein the silicone elastomer patch is made from a polydimethylsiloxane (PDMS) polymer matrix, wherein the silicone elastomer patch is a degassed patch having reduced entrapped air bubbles and comprising a functional film of optical quality.

12. The patch of claim 11, wherein the patch is trimmable to the peripheral size of an ophthalmic lens and possesses a tacky surface that can attach to an ophthalmic lens in the absence of adhesive.

13. The patch of claim 12, wherein the patch can conform to the curved surface of the ophthalmic lens under a high temperature condition or a long flow time.

14. The patch of claim 13, further comprising:
a lubricant applied to the patch to facilitate alignment on the ophthalmic lens surface.

15. The patch of claim 14, further comprising:
an ophthalmic lens having a surface, wherein the patch is applied to the surface with a lubricant sandwiched therebetween.

16. The patch of claim 11, wherein the siloxane base comprises dimethylsiloxane and the curing agent comprises dimethyl methylhydrogen siloxane.
